(19) United States
(12) Patent Application Publication
(10) Pub. No.: US 2026/0105294 A1
(43) Pub. Date: Apr. 16, 2026

(54) HETEROGENEOUS NEUROMORPHIC COMPUTING ACCELERATOR

(71) Applicant: Hewlett Packard Enterprise Development LP, Spring, TX (US)

(72) Inventors: Bassem Tossoun, Santa Barbara, CA (US); Giacomo Pedretti, San Francisco, CA (US); Xia Sheng, Azores (PT)

(21) Appl. No.: 18/917,101

(22) Filed: Oct. 16, 2024

(51) Int. Cl. G06N 3/067; G06N 3/04

(52) U.S. Cl. CPC G06N 3/0675; G06N 3/04

(57) ABSTRACT

A system for heterogeneous computing is disclosed. An example system includes crossbars, a photonic interconnect, and photonic computing circuitry. The crossbars include a first crossbar configured to perform matrix-vector multiplications and silicon photonic circuitry configured to perform matrix-vector multiplications. The photonic interconnect is configured to route signals, via routing paths, between crossbars of the plurality of crossbars. The photonic computing circuitry is integrated within the photonic interconnect. The photonic computing circuitry is configured to route signals via routing paths and perform pre-processing and post-processing of signals from the crossbars of the plurality of crossbars.

### BACKGROUND

As artificial intelligence (AI) workloads continue to expand and become more prevalent, the computational demands on computing systems executing such workloads is increasing rapidly, which may pose challenges for creating sustainable high performance computing (HPC) systems configured for AI workloads. Such HPC systems are often implemented using traditional accelerators (e.g., graphic processing units (GPUs)).

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates a computing system, according to some implementations;

FIG. 2 illustrates a computing system, according to some implementations;

FIG. 3 illustrates a system for heterogeneous computing, according to some implementations;

FIG. 4 illustrates a system for heterogeneous computing, according to some implementations; and

FIG. 5 illustrates a method for heterogeneous computing, according to some implementations.

### DESCRIPTION

Neuromorphic systems may use specialized hardware architectures, which may, for example, implement neural network algorithms more efficiently than other computing architectures, such as, for example, traditional Von Neumann-type computer architectures. In one or more examples disclosed herein, neuromorphic computing accelerators are disclosed that may include both memristor-based circuits and silicon photonic circuitry.

A memristor array can be arranged as a crossbar, which may, for example, allow the memristor crossbar array to perform matrix-vector multiplications, which are often important operations in neural network computations. Such memristor crossbar arrays may, for example, be used in dot product engines (DPEs) configured to perform dot product matrix-vector multiplications.

Silicon photonics generally refers to photonic systems, circuits, and the like that use silicon as an optical medium. Silicon photonics-based components may, for example, be used to provide high-bandwidth optical communication and/or be used to implement optical components for neural network architectures.

However, AI accelerators based on memristor crossbars can have potential bandwidth limitations when scaled to higher densities. As an example, the resistance-capacitance time delay in metal wires used to connect multiple memristors in a crossbar may restrict bandwidth to approximately 1 GHz. Additionally, the endurance and/or retention time of memristor arrays can be limited, which may, for example, constrain weight values within DPEs and content addressable memories (CAMs) implemented, at least in part, using memristor arrays to being fixed values (e.g., not easily reconfigurable at high speeds).

Silicon photonics components may also be configured to perform matrix-vector multiplications, and may also be more easily reconfigurable (e.g., in regards to updating weights of a matrix at high speeds) relative to memristor arrays. However, scalability can remain an issue for stand-alone silicon photonics, making the implementation of deep neural networks with more than a few layers using only components based on silicon photonics difficult.

In one or more examples, silicon photonics may also be used to provide circuitry for integration of memristor-based elements and silicon photonics-based elements to implement heterogeneous neuromorphic hardware components (e.g., an accelerator).

The present disclosure may heterogeneously integrate memristor crossbar structures with a silicon photonic circuitry. In some implementations, this integration allows for the density of layers and neurons in a deep neural network to be scaled through the incorporation of multiple chiplets onto a single interposer chip. In some implementations, the interposer chip functions as a silicon photonic network-on-chip (NoC), providing reconfigurable routing of signals between chiplets. Such configuration can achieve relatively high speeds through high-bandwidth optical interconnects provided by the silicon photonic NoC.

The present disclosure may utilize dot product engines (DPEs), which may include DPE arrays. The DPE array can include programmable elements (e.g., memristors of memristor crossbar arrays) that have adjustable values such as conductances or resistances. While memristors are one example of such programmable elements, a DPE array can also be implemented using various other technologies, including multi-bit flash memory cells, resistive random-access memory (ReRAM) cells, phase-change random-access memory (PCRAM) cells, magnetoresistive random-access memory (MRAM) cells, electrochemical random-access memory (ECRAM) cells, or other programmable elements. In some implementations, a DPE can be a circuit where, by encoding a matrix (e.g., a matrix of weights) into programmable elements of a crossbar array (e.g., configuring conductances of memristors), matrix-vector multiplications may be executed. Matrix-vector multiplications may be used, for example, in execution of various forms of machine learning algorithms (e.g., neural networks).

To perform heterogeneous integration (e.g., of memristor-based components and silicon photonics-based components), a system for heterogeneous computing can combine memristor crossbars and silicon photonics as a single circuitry component, monolithically or through 2.5D and/or 3D integration techniques such as 3D direct bond integration (3D DBI), oxide-oxide bonding, bump-to-bump bonding, wire bonding, flip chip bonding, or the other appropriate techniques.

A system for heterogeneous computing can support various algorithms and approaches to computation, such as, for example, transfer learning, hyperdimensional computing, convolutional neural networks, and the like. Such algorithms and approaches to computation may, for example, be implemented using memristor crossbar arrays within DPEs, CAMs, and the like. For example, transfer learning can be implemented with fixed convolutional layers using memristor crossbars and trainable fully-connected layers using silicon photonic circuits. As another example, in some implementations, silicon photonic circuitry may include a reconfigurable mesh of Mach-Zehnder interferometers (MZIs) for implementing the trainable fully-connected layers, allowing for efficient and flexible neural network training.

In some implementations, the system for heterogeneous computing includes a plurality of memristor crossbar arrays configured to perform analog matrix-vector multiplications. The memristor crossbar arrays can be implemented in various architectures, including one-transistor-one-memristor (1T1M), two-transistors-two-memristors (2T2M) configurations, self-rectifying crossbar architectures, or any other suitable architecture. These architectures can facilitate the memristor crossbar arrays to handle different computational tasks efficiently. In some implementations, the memristor crossbar arrays are integrated with silicon photonic circuitry, which may improve the overall performance and scalability of a system for heterogeneous computing.

In some implementations, silicon photonic circuitry is integrated with one or more memristor crossbars via a silicon photonic NoC. A silicon photonic NoC can be configured to provide reconfigurable routing of signals between memristor crossbars and/or between memristor crossbars and silicon photonics-based components. In some implementations, such reconfigurability allows a system for heterogeneous computing to dynamically adjust routing paths based on real-time workload requirements, which may improve the overall efficiency and flexibility of the system for heterogeneous computing.

In one or more examples, photonic computing circuitry (e.g., a silicon photonics-based NoC) can be configured to perform pre- and post-processing of signals from one or more memristor crossbars. In some implementations, such integration on a NoC reduces static power consumption and improves the efficiency of signal processing, which may provide faster and more energy-efficient computations. In some implementations, photonic computing circuitry includes microring resonators, which may, for example, be configured to perform various functions using tunable synaptic weights, which may improve system adaptability and performance.

In some implementations, a system for heterogeneous computing includes heterogeneous III-V on Si photonic circuitry, which may, for example, be configured to monolithically integrate both memristor arrays and optical devices on the same circuit. In some implementations, this integration simplifies the manufacturing process and reduces the cost and complexity of the system for heterogeneous computing, which may, for example, make a system for heterogeneous computing suitable for large-scale production. In some implementations, the heterogeneous III-V on Si photonic circuitry includes elements such as quantum dot lasers for on-chip light generation, thereby providing a reliable and efficient source of light for the photonic components of the system for heterogeneous computing.

In some implementations, the system further comprises in-memory photonic ternary content-addressable memory (TCAM) formed by integrating memristor arrays with silicon photonic phase shifters. In some implementations, the in-memory photonic TCAM is capable of highly parallel computation in a single clock cycle and allows reduction of system latency and elimination or substantial reduction of the Von Neumann bottleneck. The Von Neumann bottleneck in a computer system may be caused at least partially by a processor and memory being separate from each other, and data being transferred between them for processing. In some implementations, the in-memory photonic TCAM can be configured to perform in-situ hardware-aware training, allowing efficient and adaptive learning directly on the chip. While discussed with respect to TCAM, the memory can more generally be an CAM or similar technology.

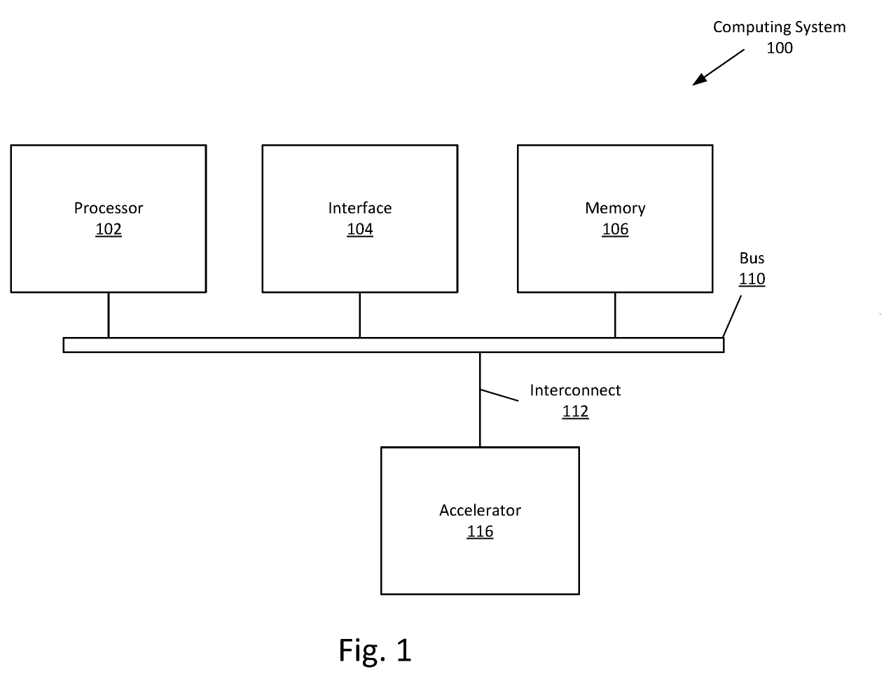

FIG. 1 depicts a computing system 100 that may be configured, for example, to accelerate neural network computations for training and inference. To achieve its desired functionality, the computing system 100 includes various hardware components. In some implementations, the computing system 100 includes a processor 102, interface(s) 104, a memory 106, and a bus 110 that facilitates communication between these components. The computing system 100 may include an accelerator 116, which may be coupled to the bus 110 via an interconnect 112 (which may be a photonic interconnect).

The computing system 100 may be implemented in an electronic device. Examples of electronic devices include servers, desktop computers, laptop computers, mobile devices, gaming systems, and the like. The computing system 100 may be utilized in any data processing scenario, including stand-alone hardware, mobile applications, or combinations thereof. Further, the computing system 100 may be used in a computing network, such as a public cloud network, a private cloud network, a hybrid cloud network, other forms of networks, or combinations thereof. In one example, the methods provided by the computing system 100 are provided as a service over a network by, for example, a third party. The computing system 100 may be implemented on one or more hardware platforms, in which the modules in the system can be executed on one or more platforms. Such modules can run on various forms of cloud technologies and hybrid cloud technologies or be offered as a Software-as-a-Service that can be implemented on or off a cloud.

In some implementations, the processor 102 retrieves executable code from the memory 106 and executes the executable code. The executable code may, when executed by the processor 102, cause the processor 102 to implement all or any portion of the functionality described herein. The processor 102 may be a microprocessor, an application-specific integrated circuit, a microcontroller, or the like.

In some implementations, the interface(s) 104 allow the processor 102 to interface with various other hardware elements, external and internal to the computing system 100. For example, the interface(s) 104 may include interface(s) to input/output devices, such as, for example, a display device, a mouse, a keyboard, etc. The interface(s) 104 may include interface(s) to an external storage device, or to a number of network devices, such as servers, switches, and routers, client devices, other types of computing devices, and combinations thereof.

The memory 106 may include various types of memory modules, including volatile and nonvolatile memory. For example, the memory 106 may include Random Access Memory (RAM), Read Only Memory (ROM), a Hard Disk Drive (HDD), a Solid State Drive (SSD), or the like. The memory 106 may include a non-transitory computer readable medium that stores instructions for execution by the processor 102. One or more modules within the computing system 100 may be partially or wholly embodied as software and/or hardware for performing any functionality described herein. Different types of memory may be used for different data storage needs. For example, in certain examples the processor 102 may boot from ROM, maintain nonvolatile storage in an HDD, and execute program code stored in RAM.

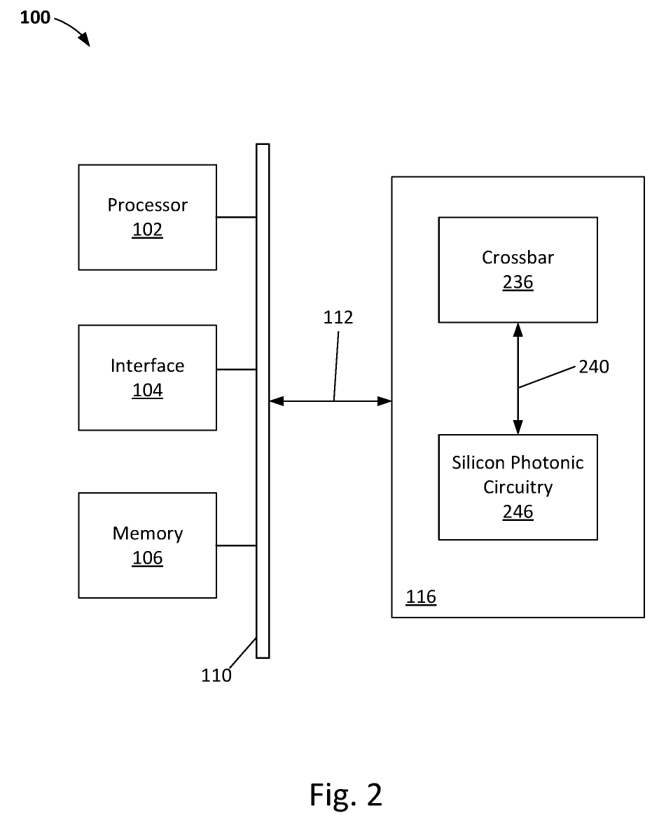

An overview of the accelerator 116 is described in FIG. 1. A more detailed view of the internal components and structure of the accelerator 116 is described in FIG. 2 below. In some implementations, the accelerator 116 may include: a silicon photonic NoC to provide interface between the accelerator 116 and the other components of the computing system 100; one or more memristor-based components, such as crossbars; silicon photonic circuitry, which may allow the computing system 100 to implement neural network layers; and/or a combination of memristor and silicon photonic components.

As an example, the accelerator 116 may include a crossbar array. In some implementations, the crossbar array includes a plurality of input electrodes, a plurality of output electrodes, and a plurality of programmable elements. The crossbar array also may be referred to as a programmable crossbar array. In some implementations, the input electrodes are arranged in subsets, e.g., in crossbar rows, the output electrodes are arranged in subsets, e.g., in crossbar columns. Each programmable element can be positioned at a crosspoint or junction of an input electrode and an output electrode. As input, the crossbar array can take a vector of signals (on the input electrodes).

In some implementations, for neural network acceleration, the processor 102 and the memory 106 may be configured to coordinate the overall execution of neural network operations, while the accelerator 116 may be utilized for efficient matrix-vector multiplications and/or other operations for the neural network computations.

For inference operations, the accelerator 116 may be advantageous. As an example, memristor crossbar arrays within the accelerator 116 can perform analog matrix-vector multiplications with high efficiency and low power consumption. This capability is useful for convolutional neural networks (CNNs) and fully connected layers, where numerous matrix multiplications may be appropriate.

In some implementations, during training operations, the system 100 may use the processor 102, the memory 106, and the accelerator 116. In some implementations, the processor 102 and the memory 106 may execute traditional computing operations, while the accelerator 116 may perform neuromorphic computing operations. As an example, the processor 102 and the memory 106 may handle tasks such as weight updates and backpropagation calculations, while the accelerator 116 may continue to accelerate forward pass computations. This division of performing functionalities may allow for efficient parallel processing during the training phase.

In some implementations, the interconnect 112 facilitates communication between the bus 110 (communicatively coupled to the processor 102 and the memory 106) and the accelerator 116, allowing the computing system 100 to use the advantageous features of the processor 102 and the memory 106 as well as the accelerator 116.

In some cases, the processor 102, the memory 106, and the accelerator 116 may be implemented as separate chiplets that are heterogeneously integrated onto a single interposer chip. This configuration can allow the density of layers and neurons in a deep neural network to be scaled, potentially improving the performance and efficiency of the computing system 100.

Referring to FIG. 2, a block diagram of a computing system 100 for heterogeneous neuromorphic computing is illustrated. In some implementations, the computing system 100 comprises a processor 102, memory 106 and an accelerator 116 connected via the interconnect 112.

In some implementations, the memory 106 and the processor 102 are connected by the bus 110, allowing for data exchange between these components. In some aspects, the memory 106 may store instructions for the processor 102 to execute, while in other cases, the memory 106 may store data for processing by the processor 102.

In some implementations, the accelerator 116 includes at least a crossbar 236 (which may be a memristor array) and silicon photonic circuitry 246. In some implementations, the crossbar 236 may be a DPE array. In some implementations, the crossbar 236 and the silicon photonic circuitry 246 are connected by a bidirectional data flow coupling 240 (which may be a photonic interconnect), providing communication and data transfer between the crossbar 236 and the silicon photonic circuitry 246. In some cases, the crossbar 236 and the silicon photonic circuitry 246 may be configured to perform matrix-vector multiplications for the neural network computations.

In some implementations, the interconnect 112 facilitates data exchange and communication between the bus 110 (coupling the processor 102 and the memory 106) and the accelerator 116. This interface allows the processor 102 to interact with and control the crossbar 236 and the silicon photonic circuitry 246, integrating Von Neumann computing capabilities of the processor 102 and the memory 106 with memristor-based neuromorphic processing.

In some implementations, the computing system 100 may include a heterogeneous III-V on Si photonic circuitry. The heterogeneous III-V on Si photonic circuitry may involve the integration of III-V materials, such as gallium arsenide (GaAs) and indium phosphide (InP), onto a silicon (Si) substrate. In some implementations, the heterogeneous III-V on Si photonic circuitry may be configured to monolithically integrate the electronic crossbar 236 and optical devices on the same circuit. In some implementations, this integration may simplify the manufacturing process and reduce the cost and complexity of the system for heterogeneous computing 400, potentially making the system for heterogeneous computing 400 more available for large-scale production.

In some cases, the heterogeneous III-V on Si photonic circuitry may be a part of the interconnect 112 that routes signals in the computing system 100 between the bus 110 (coupling the processor 102 and the memory 106) and the accelerator 116. In some aspects, the interconnect 112 may be configured to provide high-speed, low-latency communication between the bus 110 and the accelerator 116, potentially improving the overall performance and efficiency of the computing system 100.

In some implementations, by combining Von Neumann processing elements (such as the processor 102 and the memory 106) with memristor technology, the computing system 100 potentially allows more efficient and capable neuromorphic computing operations. As an example, the computing system 100 may allow flexible data processing and storage across both Von Neumann and memristor-based architectures.

In some cases, the computing system 100 may be configured to support various computing architectures for transfer learning, hyperdimensional computing, content addressable memories, and convolutional neural network architectures.

For inference, the crossbar 236 may be programmed with the weights of a pre-trained neural network. When input data is provided to the computing system 100, the crossbar 236 can rapidly perform the matrix-vector multiplications, accelerating the forward pass of the neural network. The bidirectional data flow coupling 240 (e.g., the photonic interconnect) between the crossbar 236 and the silicon photonic circuitry 246 allows for efficient data sharing and may allow the implementation of more complex network architectures.

During training, the processor 102 may coordinate the overall training process in the computing system 100, including tasks such as data preprocessing, loss calculation, and optimization algorithms. The accelerator 116 can be utilized to accelerate forward pass computations. After each forward pass, the processor 102 may calculate the gradients and update the weights stored in the crossbar 236. The bus 110 between the memory 106 and the processor 102 allows efficient transfer of training data and intermediate results.

In some implementations, the crossbar 236 may include one or more crossbar arrays that may include programmable elements. In some implementations, the programmable elements may be circuit elements that may have programmable values (e.g., conductances, resistances, and the like). The programmable elements may be non-volatile analog devices, which may be adapted to store one or more bits of data. An example of a programmable element is a memristor or a ReRAM cell, which may include a dielectric layer (e.g., an oxide layer) between two conductive (e.g., metal, metal compound, and/or highly doped semiconductor) layers. When the programmable elements are memristors, the crossbar array is a memristor array. Other examples of programmable elements include multi-bit flash memory cells, ReRAM cells, PCRAM cells, MRAM cells, ECRAM cells, and/or other suitable programmable elements.

The crossbar array may also include other peripheral circuitries associated with the crossbar array. For example, the crossbar array may include drivers connected to the input electrodes. An address decoder can be used to select an input electrode and activate a driver corresponding to the selected input electrode. The driver for a selected input electrode can drive a corresponding input electrode with different voltages corresponding to a matrix-vector multiplication or the process of setting programmable values within the programmable elements of the crossbar array. Similar driver and decoder circuitry may be included for the output electrodes. Control circuitry may also be used to control application of voltages at the inputs of the crossbar array. Input signals to the input electrodes and the output electrodes can be analog signals. The peripheral circuitry can be fabricated using semiconductor processing techniques in the same integrated structure or semiconductor die as the crossbar array.

In some implementations, the crossbar array can include Z input electrodes and U output electrodes. As described in further detail below, there are at least two operations that occur during operation of the crossbar array. The first operation is to program the programmable elements in the crossbar array so as to map the mathematic values in a Z×U matrix to the programmable elements for crossbar array. The second operation is the dot product or matrix-vector multiplication operation. In this operation, input voltages are applied to the input electrodes and output currents are obtained from the output electrodes, corresponding to the result of multiplying a Z×1 vector with the Z×U matrices. The input voltages are below the threshold of the programming voltage of the programmable elements so the resistance values of the programmable elements in the crossbar array are not changed during the matrix-vector multiplication operation.

As an example, in implementations where the crossbar array uses memristors as programmable elements, the following programming process may be used. The crossbar array may be programmed to store the Z×U matrices by modifying the conductances of the programmable elements. In some implementations, the conductances of the programmable elements are values corresponding to the Z×U matrices. The conductances of the programmable elements may be modified by imposing a voltage across the programmable elements using the input electrodes, the output electrodes, and corresponding voltage drivers. In some implementations, the voltage difference imposed across a programmable element generally determines the resulting conductance of that programmable element. The programming process may be performed row-by-row.

A matrix-vector multiplication may be executed through the crossbar array by applying a set of voltages simultaneously along the input electrodes of the crossbar array and collecting the currents through the output electrodes. The signal generated on an output electrode is weighted by the corresponding conductance of the programmable elements at the crosspoints of the output electrode with the input electrodes, and that weighted summation is reflected in the current at the output electrode. Thus, the relationship between the voltages at the input electrodes and the currents at the output electrodes is represented by a vector-matrix multiplication of the input vector (e.g., the search vector) with the Z×U matrix determined by the conductances of the programmable elements for crossbar array.

The memristor crossbar arrays can be implemented in various architectures, including 1T1M, 2T2M configurations, and self-rectifying crossbar architectures. In some implementations, the 1T1M configuration may have an architecture, where each memristor is coupled to a single transistor, which functions as a switch to control the flow of current through the memristor.

In the 2T2M configuration, each memristor may be coupled to two transistors, which allows for a higher density of memristors to be coupled to a single circuit. The 2T2M architecture may offer high scalability and performance. In the self-rectifying crossbar architecture, the memristors may be arranged in a crossbar pattern, and each memristor may be coupled to two electrodes. The self-rectifying crossbar architecture may allow for bidirectional current flow, which can be used to implement logic functions and other computing operations.

In some implementations, the computing system 100 may include an in-memory photonic CAM (e.g., TCAM) formed by integrating memristor arrays with silicon photonic phase shifters. Such configuration may provide the advantages of memristor-based storage and photonic signal processing to create an efficient and parallel search configuration.

The in-memory photonic CAM may be utilized to store ternary states (e.g., 0, 1, or “don't care” states) for each bit of the stored patterns. The silicon photonic components, which may be integrated within the photonic interconnect, can be used to perform the search operation optically. In some aspects, each stored pattern may be represented by a unique combination of phase shifts in the photonic circuit.

When performing a search operation, the input pattern may be encoded into the phases of multiple wavelengths of light. This multi-wavelength signal can be sent through the photonic circuit, where it interacts with the phase shifters controlled by the memristor states. The resulting interference patterns may be detected at the output, with a match indicated by constructive interference at a specific output port.

The architecture having the in-memory photonic CAM may allow for parallel search operations, as multiple patterns can be searched simultaneously using different wavelengths of light. In some cases, the in-memory photonic CAM may be configured to perform the parallel searches in a single clock cycle, potentially reducing system latency and reducing the Von Neumann bottleneck potentially associated with the computing system 100.

The integration of the crossbar 236 and silicon photonics in the CAM configuration may offer several advantages, such as high-speed operation, low power consumption, scalability, and/or reconfigurability. The use of photonic signaling may allow for relatively fast search operations, potentially operating at speeds primarily affected at least partially by the modulation rate of the optical signals. The non-volatile nature of memristor storage combined with the low-loss characteristics of silicon photonics may result in relatively low power consumption. The compact nature of the crossbar 236 and silicon photonic components may allow for high-density integration, potentially enabling large-scale CAM arrays. The programmable nature of the crossbar 236 and photonic phase shifters may allow for dynamic reconfiguration of the CAM, allowing adaptive search patterns and relatively flexible functionality.

In some implementations, the in-memory photonic CAM may be used for various applications of the computing system 100. For instance, the in-memory photonic CAM may be used for rapid pattern matching in convolutional neural networks, efficient address translation in network routing, and/or fast similarity search in content-based image retrieval systems. The ability to perform these operations with relatively high parallelism and low latency may improve the overall performance of AI workloads running on the computing system 100.

The computing system 100 can combine the memristors and silicon photonics on a single circuitry, monolithically or through 2.5D and/or 3D integration techniques. The integration techniques may include: oxide-oxide bonding; bump-to-bump bonding; wire bonding; flip chip bonding; monolithic integration; wafer-level bonding; through-silicon via technology; interposer-based integration; and other suitable integration techniques. These techniques may be used individually or in combination to achieve the desired integration of the memristors and silicon photonics.

In some implementations, the oxide-oxide bonding technique may involve directly bonding two oxide surfaces together, potentially allowing for a relatively strong and stable connection between the crossbar 236 and photonic components of the silicon photonic circuitry 246. In some cases, this technique may utilize small metal protrusions on the surfaces of the crossbar 236 and photonic components to create electrical and mechanical connections between them.

In certain aspects, thin wires may be used to couple the crossbar 236 and photonic components, potentially allowing for flexible integration of different technologies. Some implementations may employ the technique where one of the components is flipped and directly bonded to the other, allowing a more compact integration with shorter electrical paths.

In some cases, the crossbar 236 and photonic components may be fabricated on the same substrate in a single process, potentially allowing improved performance and reduced manufacturing complexity. In some implementations, a technique may involve bonding wafers of the crossbar 236 and photonic components before dicing, potentially allowing large-scale integration and improved manufacturing efficiency.

In some implementations, vertical electrical connections passing through a silicon wafer may be used to connect the crossbar 236 and photonic layers in a 3D stack. Some aspects may utilize an interposer layer to couple the crossbar 236 and photonic components, potentially allowing for heterogeneous integration of different process technologies.

In some implementations, an interposer-based 2.5D integration may be used when the interposer may couple a memristor crossbar and silicon photonic components. The interposer may be a substrate with high-density interconnects, allowing for heterogeneous integration of different process technologies. The memristor crossbar can be a DPE, CAM, or other applications.

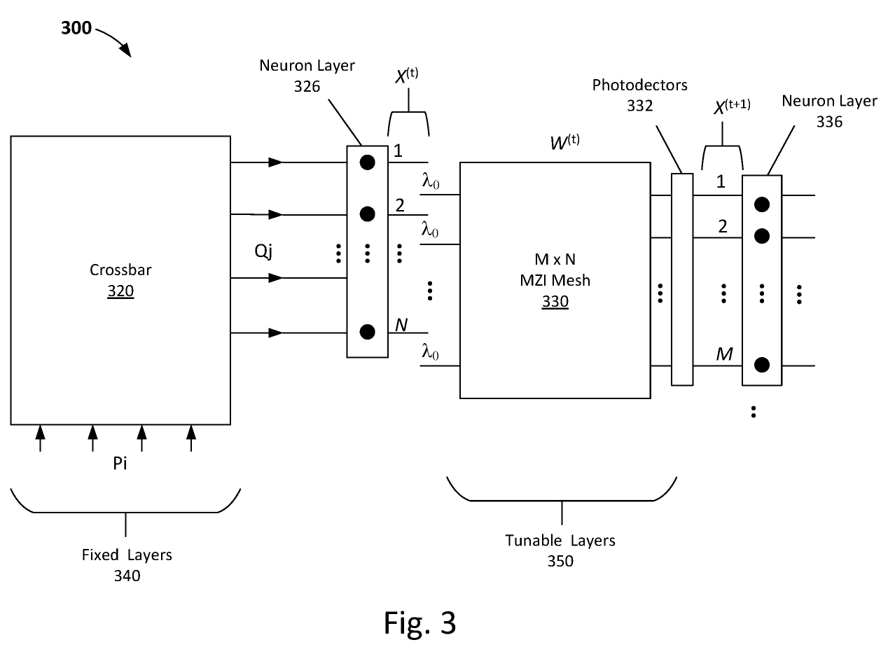

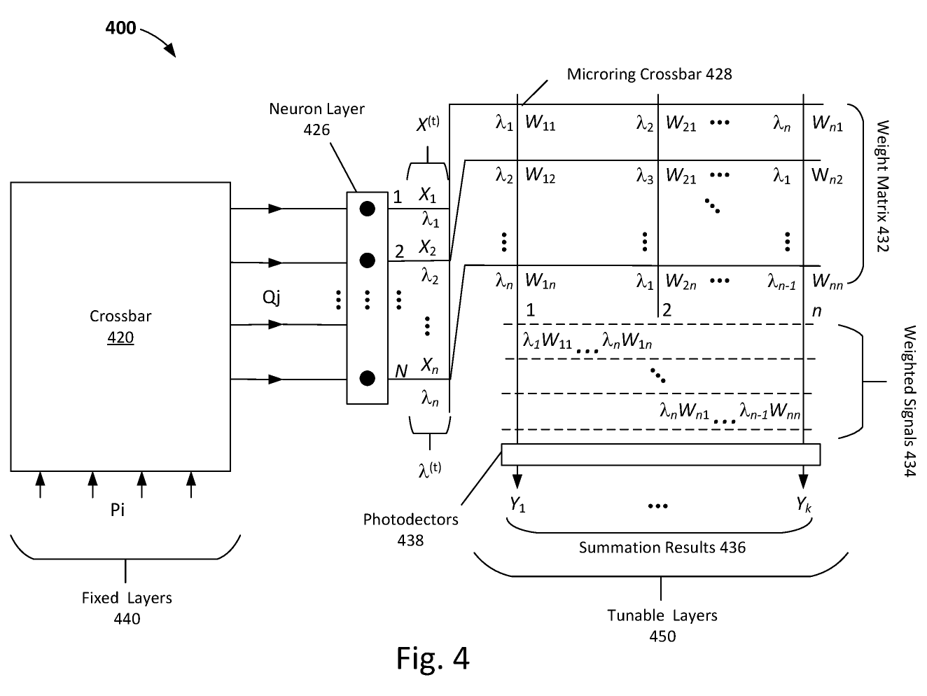

FIG. 2 provided an overview of the components of the accelerator 116. Specific implementations of these components, particularly the crossbar 236 and the silicon photonic circuitry 246, are illustrated in FIGS. 3 and 4, which illustrate different examples of approaches to implementing these components.

Referring to FIG. 3, a system for heterogeneous computing 300 is illustrated. The system for heterogeneous computing 300 may provide integration of fixed and tunable optical layers in a neural network architecture. In some implementations, fixed layers of the neural network may be implemented using a dot product engine 320 and tunable layers may be implemented using an MZI mesh 330.

FIG. 3 illustrates a specific implementation of the components introduced in FIGS. 1 and 2. In FIG. 3, the crossbar 320 may correspond to the crossbar 236 shown in FIG. 2 (which may be a memristor-based component), while the MZI mesh 330 may represent an implementation of the silicon photonic circuitry 246.

In some implementations, the MZI mesh 330 may include a reconfigurable optical network structure composed of multiple interconnected MZIs. The MZI mesh 330 may be configured to perform matrix-vector multiplications and other linear transformations on optical signals. The MZI mesh 330 may include a two-dimensional M×N array of MZIs, where each MZI can be individually tuned to adjust its phase shift and transmission properties.

In some implementations, the system for heterogeneous computing 300 facilitates the flow of data through the neural network architecture. The fixed layers 340 may be implemented using memristor-based crossbar arrays, which may be configured to perform matrix-vector multiplications efficiently. The dot product engine 320 receives inputs, e.g., the input vector Pi. In some cases, the fixed layers 340 may be pre-trained and optimized for specific tasks or domains, providing a relatively stable basis for the neural network computations.

An output Qj from the dot product engine 320 is then passed to the neuron layer 326, which processes the vector Qj and outputs a vector X(t). The neuron layer 326 serves as the interface between the fixed layers 340 and the tunable layers 350. In some implementations, the neuron layer 326 may have N neurons, labeled from 1 to N. Each element of the neuron layer 326 may be associated with a wavelength λ0, performing wavelength division multiplexing. In some implementations, the wavelength λ0 is applied to vector X(t) providing an input signal to the MZI mesh 330. Such a technique allows multiple signals to be transmitted relatively simultaneously using different wavelengths of light, potentially increasing overall bandwidth and computational efficiency of the system for heterogeneous computing 300.

In some implementations, the MZI mesh 330 represents the tunable layers 350 of the neural network. The MZI mesh 330 may be configured as an M×N matrix that receives input from the dot product engine 320 via the neuron layer 326. The MZI mesh 330 may perform matrix operations on the input data, allowing for dynamic adjustment of the network parameters. In some aspects, the MZI mesh 330 may be implemented using silicon photonic components, such as Mach-Zehnder interferometers, which can be rapidly reconfigured to modify the network behavior.

In some implementations, the MZI mesh 330 applies the weights W(t) to the input signal. In some implementations, the MZI mesh 330 produces signals which, after being processed by the photodetectors 332, provide the output X(t+1) which is further fed into the neuron layer 336.

The tunable layers 350 implemented by the MZI mesh 330 may offer several advantages such as adaptability, fine-tuning, and transfer learning. The MZI mesh 330 may be used to implement the tunable layers 350 of a neural network, allowing for dynamic adjustment of network weights through control of the individual MZIs. The MZI mesh 330 may allow parallel processing of multiple wavelengths of light, potentially increasing the computational throughput and efficiency of the neural network operations.

As an example, the weights and connections within the tunable layers 350 can be dynamically adjusted, allowing the neural network to adapt to new tasks or changing conditions. The tunable layers 350 may be used to refine the neural network performance on specific tasks, building upon the general features extracted by the fixed layers 340. The combination of the fixed layers 340 and the tunable layers 350 may facilitate transfer learning approaches, where a pre-trained network is adapted to new domains or tasks.

In some implementations, the photodetectors 332 may be PIN photodiodes having p-type region, intrinsic region, and n-type region; Schottky photodiodes; avalanche photodiodes (APDs); metal-semiconductor-metal (MSM) photodetectors; complementary metal-oxide-semiconductor (CMOS) image sensors (CISs); and other suitable photodetectors.

In some implementations, the photodetectors 332 may be configured to rapidly convert optical signals to electrical signals. In some aspects, the photodetectors 332 may allow fast and efficient signal processing at the interface between the photonic and electronic components of the system for heterogeneous computing 300, e.g., at the interface between the MZI mesh 330 and the neuron layer 336.

In some implementations, the photodetectors 332 may act as neurons themselves. When acting as neurons, the photodetectors 332 may be configured to perform the following operations: light-to-current conversion, thresholding, nonlinear response, temporal integration, wavelength sensitivity, local processing, spike generation, adaptive sensitivity, multi-input integration, output transmission, and other suitable operations.

As an example, the photodetectors 332 may absorb incoming light from the MZI mesh 330 and convert it into electrical current. The strength of this current may correspond to the intensity of the incoming light, effectively representing the input signal strength. In some implementations, the photodetectors 332 may incorporate a thresholding mechanism. The photodetectors 332 may generate an output signal when the incoming light intensity exceeds a certain level, mimicking the activation threshold of neurons.

The photodetectors 332 may be designed with a nonlinear response curve, similar to activation functions in artificial neurons. For example, the output of the photodetectors 332 may saturate at high input intensities, approximating a sigmoid function. The photodetectors 332 may accumulate charge over relatively short time periods, effectively integrating the incoming optical signals. The photodetectors may respond to patterns in the input signal over time.

In some cases, the photodetectors 332 may be configured to have different sensitivities to various wavelengths. This may allow a single photodetector to weight inputs differently based on the wavelength of the input, similar to synaptic weighting in neural networks. The photodetectors 332 may incorporate electronic circuits that may perform computations on the detected signals, such as summation or scaling.

In some implementations, the photodetectors 332 may generate spike-like electrical outputs in response to optical inputs, mimicking the action potentials of neurons. The photodetectors 332 may dynamically adjust their sensitivity based on recent input history, implementing a form of short-term plasticity.

Each of the photodetectors 332 may receive inputs from multiple optical paths in the MZI mesh 330, allowing the photodetectors 332 to integrate multiple “synaptic” inputs. The electrical output from the photodetectors 332 may be used as input for subsequent electronic processing stages or converted back into optical signals for further photonic processing.

In some implementations, the neuron layer 326 receives an output from the photodetectors 332. The neuron layer 326 may have M neurons labeled from 1 to M. The neuron layer 326 may provide the results of the computations performed by both the fixed layers 340 and the tunable layers 350.

This integration of the fixed layers 340 and the tunable layers 350 may offer a balance between stability and adaptability in neural network computations. As an example, the fixed layers 340 may provide a consistent basis for feature extraction, while the tunable layers 350 may allow for task-specific optimization and adaptation of the neural network to new domains.

Referring to FIG. 4, a system for heterogeneous computing 400 is illustrated. The system for heterogeneous computing 400 may have a neural network architecture with a microring crossbar structure, according to some implementations. The system for heterogeneous computing 400 may include fixed layers 440 (which may include a dot product engine 420), a neuron layer 426, and tunable layers 450.

FIG. 4 illustrates an implementation of the accelerator components introduced in FIGS. 1 and 2. In FIG. 4, the dot product engine 420 may correspond to the crossbar 236 from FIG. 2. In some implementations, the tunable layers 450, implemented using a microring crossbar 428, represent an implementation of the silicon photonic circuitry 246 from FIG. 2.

In some aspects, the dot product engine 420 may be implemented using memristor crossbar arrays. The memristor crossbar arrays can perform matrix-vector multiplications for neural network computations. The memristor crossbar arrays can be configured to perform the matrix-vector multiplications operations efficiently and at high speeds, potentially improving the performance of the neural network.

In some implementations, the fixed layers 440 are implemented using the dot product engine 420. In some implementations, the dot product engine 420 is coupled to the neuron layer 426. The fixed layers 440 may perform initial processing on the input data Pi before passing its output Qj from the crossbar 420 to the neuron layer 426. The neuron layer 426 may include multiple neurons, labeled from 1 to N, each associated with a corresponding value of a vector X(t) and a corresponding wavelength λ(t). The output X(t), e.g., X1, …, Xn, from the neuron layer 426 is fed into the tunable layers 450. Each input signal X1, …, Xn may be associated with a specific wavelength λ1, …, λn.

The tunable layers 450 may include a microring crossbar structure (e.g., the microring crossbar 428). In some aspects, the microring crossbar structure in the tunable layers 450 may be implemented using photonic microring crossbar cores. The microring crossbar 428 may include a matrix of weights (W) 432 corresponding to different wavelengths (λ). As an example, the microring crossbar 428 may contain a weight matrix 432 with elements Wij, where the weight matrix 432 may have n columns and n rows. Each element corresponds to a specific wavelength λ1 through λn. In some implementations, the microring crossbar 428 performs matrix multiplication operations on the input X(t) received from the neuron layer 426.

In some implementations, the weights of the weight matrix 432 are applied to the microring crossbar 428 in the tunable layers 450. The weights of the weight matrix 432 allow for adjustment of the weights in the microring crossbar 428, allowing the system for heterogeneous computing 400 to adapt and learn based on the newly received information provided by the weight matrix 432. In some cases, the weights of the weight matrix 432 may be generated by instructions received from the processor 102 or the accelerator 116, depending on the specific implementation of the system for heterogeneous computing 400.

As the input signals λ(t) corresponding to the vector X(t) pass through the microring crossbar 428, the input signals λ(t) interact with the microrings representing the weights Wij. The microrings in the microring crossbar 428 may be configured to respond differently to various wavelengths. This approach allows each input signal λ(t) to be weighted according to the weights in the matrix corresponding to each input signal λ(t).

In some implementations, when a wavelength of the input signal λ(t) matches the resonance condition of the microring in the microring crossbar 428, the input signal λ(t) is modulated based on the weight value Wij represented by that microring. Such modulation of input signal λ(t) provides matrix-vector multiplication results (e.g., λ₁W₁₁, …, λₙ₋₁Wₙₙ) representing the weighted signals 434.

The weighted signals 434 from multiple input-weight interactions may be combined within the micro ring crossbar 428 structure. After passing through the photodetectors 438, the output of the tunable layers 450 may represent a set of summation results 436 of the weighted signals 434 along each column k, the column-wise summation results 436 being labeled Y1 to Ky, where Ky may be a vector corresponding to the k-th column in the micro ring crossbar 428. For example, the Ky vector may include the summation of the vector-matrix multiplication results (e.g., λ₁W₁₁, λ₂W₁₂, …, λₙW₁ₙ) in the k-th column of the micro ring crossbar 428. Such outputs Y1 through Ky represent the processed information from the system for heterogeneous computing 400. In some cases, the output of the tunable layers 450 may be used for further processing or analysis.

In some implementations, the photodetectors 438 may be PIN photodiodes, Schottky photodiodes, APDs, MSM photodetectors, CISs, and other suitable photodetectors. In some implementations, the photodetectors 438 may be configured to rapidly convert optical signals to electrical signals. In some aspects, the photodetectors 438 may allow fast and efficient signal processing at the interface between the photonic and electronic components of the system for heterogeneous computing 400.

In some aspects, the system for heterogeneous computing 400 can be configured to implement multiple neural network architectures using different combinations of the memristor crossbar arrays and the photonic microring crossbar arrays. For example, the system 400 may implement a convolutional neural network architecture with convolutional layers implemented using the memristor crossbar arrays and fully connected layers implemented using the photonic microring crossbar arrays.

In some implementations, the system for heterogeneous computing 400 may include a heterogeneous III-V on Si photonic circuitry. The heterogeneous III-V on Si photonic circuitry may be integrated with other components of the system for heterogeneous computing 400, such as the dot product engine 420, and the neuron layer 426. Such integration may allow for efficient communication between the electronic and photonic components of the system for heterogeneous computing 400.

In some implementations, the heterogeneous III-V on Si photonic circuitry may include quantum dot lasers for on-chip light generation, potentially providing a relatively reliable and efficient source of light for the photonic components of the system for heterogeneous computing 400. Such photonic components may include the MZI mesh 330 (e.g., as shown in FIG. 3), the microring crossbar 428, and the photodetectors 438.

Quantum dot lasers in the heterogeneous III-V on Si photonic circuitry may provide light sources for various wavelengths λ0, λ1 through λn used in the system for heterogeneous computing 400. The different wavelengths λ0, λ1 through λn may be used in the microring crossbar 428 to perform parallel computations and apply the weight matrix 432 to the wavelengths λ0, λ1 through λn.

In some cases, the systems for heterogeneous computing 300 and 400 may implement an HPC architecture using a combination of the memristor crossbar arrays and the photonic microring crossbar cores. HPC may, as an example, use high-dimensional vectors for information representation and manipulation. In such configuration, the memristor crossbar arrays can perform matrix-vector multiplications, while the photonic microring crossbar arrays can perform high-dimensional vector operations.

In some implementations, the systems for heterogeneous computing 300 and 400 may be configured to perform in-situ hardware-aware training using the tunable layers 350 and 450 implemented with MZI mesh 330 and the photonic microring crossbar 428, respectively. Such approach can accelerate the training process for the neural network and improve performance of the neural network. The in-situ hardware-aware training can be performed directly on the chip, using high-speed, reconfigurable microring resonators as tunable synaptic weights.

The microring resonators in the photonic computing circuitry (e.g., in the microring crossbar 428) may be programmed with tunable synaptic weights to implement different neural network architectures. Such microring resonators can be relatively rapidly reconfigured, allowing for dynamic adjustment of the neural network parameters during the training process. In some cases, the resonance wavelength of each microring can be tuned by applying a voltage or current, effectively changing the strength of the synaptic connection it represents.

This hardware-aware training approach may offer several advantages such as reduced training time; improved energy efficiency; improved accuracy; and/or scalability. As an example, by performing weight updates directly on the chip, the systems for heterogeneous computing 300 and 400 may reduce the time required for each training iteration. The use of photonic components for weight storage and updates may result in relatively low power consumption. Hardware-aware training may account for device-specific characteristics and variations, potentially providing robust and accurate models. The relatively compact nature of microring resonators may allow for the implementation of large-scale neural networks with a high density of tunable synaptic connections.

In some implementations, the use of microring resonators as tunable synaptic weights, combined with the parallel processing capabilities of the memristor and photonic crossbar arrays, may result in performance improvements. For instance, the system may achieve an increase of about 50 times in multiply-accumulate (MAC) operations per second compared to electronic neural network accelerators which do not use the systems for heterogeneous computing 300 and 400. Such increase in computational throughput may allow the training and inference of larger and more complex neural network models.

In some implementations, the integration of photonic components and in-situ training may lead to energy savings. In some cases, the systems for heterogeneous computing 300 and 400 may achieve a reduction of about 100 times in energy consumption compared to electronic neural network processors which do not use the systems for heterogeneous computing 300 and 400. This improvement in energy efficiency may be due to the low-loss characteristics of silicon photonics, the non-volatile nature of memristor storage, and the reduced data movement enabled by in-situ training.

Such performance metrics may allow the systems for heterogeneous computing 300 and 400 to be highly efficient and powerful platforms for AI workloads, potentially allowing new applications and capabilities in areas such as edge computing, real-time data analytics, and/or large-scale machine learning.

In some implementations, the systems for heterogeneous computing 300 and 400 may implement dynamic routing in the neural network. The photonic interconnect (which may be the interconnects 112 and/or 240) in the systems for heterogeneous computing 300 and 400 can be configured to provide dynamic adjustment of the routing paths based on real-time or near real-time workload requirements. Such feature can improve the overall efficiency and flexibility of the systems for heterogeneous computing 300 and 400.

In some implementations of the computing system 100, the photonic computing circuitry integrated within the photonic interconnect (e.g., interconnect 112 and/or 240) may be configured to perform pre-processing and post-processing of signals from one or more memristor crossbars (e.g., from the crossbar 236) and/or the silicon photonic circuitry 246. In some implementations, pre-processing of signals may be implemented using the following techniques: signal normalization, a wavelength conversion, noise reduction, data encoding, signal splitting, and/or other techniques for pre-processing of signals, or combinations thereof.

In some implementations, the photonic computing circuitry of the photonic interconnect may normalize input signals before the signals reach the dot product engines 320 and 420, the MZI mesh 330, or the microring crossbar 428. This technique may involve adjusting the amplitude and/or power of optical signals to provide consistent input levels.

In some implementations, the pre-processing may include converting input signals to specific wavelengths λ0, λ1 through λn which are compatible with the MZI mesh 330 and/or the microring crossbar 428.

In some implementations, the photonic computing circuitry of the photonic interconnect may implement optical filtering techniques to reduce noise in the input signals before they are processed by the memristor crossbars (e.g., from the crossbar 236) and/or the silicon photonic circuitry 246.

In some cases, pre-processing may include encoding input data into a format suitable for processing by the memristor crossbars or photonic components. The photonic computing circuitry of the photonic interconnect may split input signals for parallel processing by multiple crossbars or different sections of the MZI mesh 330.

In some implementations, post-processing of signals may include: signal amplification, wavelength demultiplexing, nonlinear activation, error correction, data aggregation, format conversion, and/or other techniques for pre-processing of signals, or combinations thereof.

In some implementations, after processing by the memristor crossbars, the photonic computing circuitry of the photonic interconnect may amplify relatively weak output signals to improve the signals so that the signals can be accurately detected by the photodetectors 332 and/or 438.

In implementations using wavelength division multiplexing, the post-processing may include separating different wavelengths λ0, λ1 through λn that carry distinct output information.

In some implementations, the photonic computing circuitry of the photonic interconnect may implement nonlinear activation functions, such as those used in neural networks, on the output signals from the MZI mesh 330 or the microring crossbar 428.

In some cases, the post-processing may include error correction techniques to improve the reliability of the output signals. In some implementations, the photonic computing circuitry of the photonic interconnect may combine outputs from multiple the memristor crossbars and/or sections of the MZI mesh 330 to produce results.

The post-processing may include converting optical signals back to electronic format for further processing by the processor 102 or other components of the computing system 100.

By performing these pre- and post-processing operations, the photonic computing circuitry of the photonic interconnect may improve the functionality and efficiency of the computing system 100. Such pre- and post-processing may allow for relatively flexible and powerful signal processing capabilities, potentially improving the overall performance of neural network computations and other tasks performed by the computing system 100.

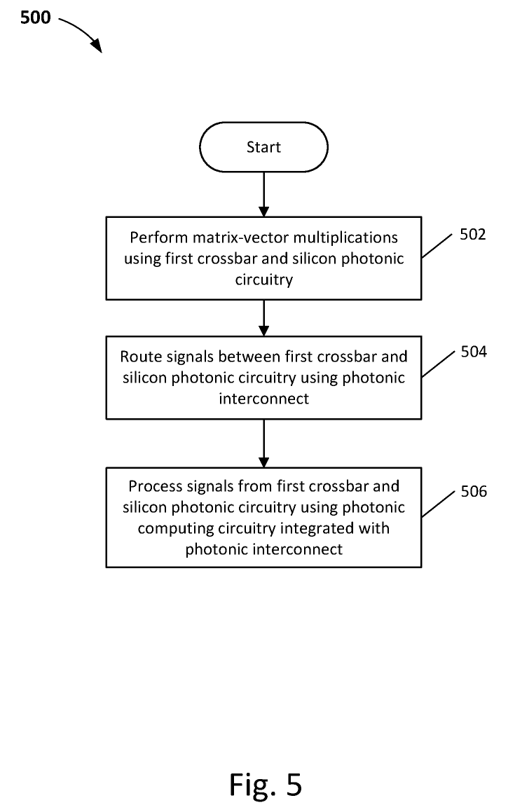

Referring to FIG. 5, a flowchart for a method 500 of heterogeneous computing is illustrated. The method 500 can provide signal processing in a hybrid memristor-photonic computing system (e.g., the computing system 100 or the systems for heterogeneous computing 300 and 400). As depicted in step 502, the method 500 begins with performing matrix-vector multiplications using the crossbar 236, 320, and/or 420 (which may include one or more memristor crossbar arrays) and silicon photonic circuitry 246 (which may include the MZI mesh 330 and/or the photonic microring crossbar 428). As an example, the memristor crossbar array, which may be implemented as part of the crossbar 320 as shown in FIG. 3 or the crossbar 420 as shown in FIG. 4, performs matrix-vector multiplications efficiently and at high speeds. The MZI mesh 330 as shown in FIG. 3 or the photonic microring crossbar 428 as shown in FIG. 4, may perform matrix-vector multiplications, potentially improving the performance of the neural network.

Following the matrix-vector multiplications, the method 500 proceeds to route signals between the crossbar 236, 320, and/or 420 and the silicon photonic circuitry 246 (e.g., the MZI mesh 330 and/or the photonic microring crossbar 428) using a photonic interconnect as depicted in step 504. In some cases, the interconnect 112, which may be implemented as part of a computing system 100 as shown in FIG. 2, facilitates data exchange and communication between the processor 102, the memory 106, and the accelerator 116. This interconnect 112 allows the processor 102 to interact with and control the crossbar 236 and the silicon photonic circuitry 246, integrating Von Neumann computing capabilities with neuromorphic processing of memristor-based and/or silicon photonics.

The step 506 of the method 500 involves processing signals from the crossbar 236, 320, and/or 420 and the silicon photonic circuitry 246 (e.g., the MZI mesh 330 and/or the photonic microring crossbar 428) using photonic computing circuitry integrated with the photonic interconnect (e.g., interconnect 240). In some aspects, the silicon photonic circuitry 246, which may be integrated within a silicon photonic NoC as shown in FIG. 2, is configured to route signals via routing paths and perform pre- and post-processing of signals from the plurality of crossbar cores (e.g., the crossbar 236, 320, and/or 420 and silicon photonic circuitry 246). This integration reduces static power consumption and improves the efficiency of signal processing, providing faster and more energy-efficient computations.

In some cases, the method 500 may further include dynamically adjusting routing paths in the photonic interconnect based on real-time or near real-time workload requirements. This feature can improve the overall efficiency and flexibility of the systems for heterogeneous computing 300 and 400. The dynamic adjustment of routing paths can be performed by the interconnects 112 and 240, which may be configured to provide dynamic adjustment of the routing paths based on real-time workload requirements as shown in FIG. 2.

The method 500 provides a high-performance, energy-efficient, and scalable solution for AI workloads, addressing the limitations of current AI accelerators. The method 500 combines Von Neumann processing elements (such as the processor 102 and the memory 106) with memristor technology, potentially allowing efficient and capable neuromorphic computing operations. The arrangement allows for flexible data processing and storage across Von Neumann and memristor-based architectures.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. Steps may operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A system for heterogeneous computing, the system comprising:
a plurality of crossbars, wherein the plurality of crossbars comprises:
a first crossbar configured to perform matrix-vector multiplications; and
silicon photonic circuitry configured to perform matrix-vector multiplications;
a photonic interconnect configured to route signals, via routing paths, between crossbars of the plurality of crossbars; and
photonic computing circuitry integrated within the photonic interconnect, the photonic computing circuitry configured to route signals via routing paths and perform pre-processing and post-processing of signals from the crossbars of the plurality of crossbars.

2. The system of claim 1, wherein the photonic interconnect comprises a heterogeneous III-V on Si photonic circuitry configured to couple the first crossbar and the silicon photonic circuitry on the same circuit.

3. The system of claim 1, wherein the system is configured to implement a neural network with fixed layers using the first crossbar and tunable layers using the silicon photonic circuitry.

4. The system of claim 3, wherein the system is configured to perform in-situ hardware-aware training using the tunable layers implemented with the silicon photonic circuitry.

5. The system of claim 1, wherein the system is configured to perform parallel computation in a single clock cycle using the photonic interconnect and the crossbars of the plurality of the crossbars.

6. The system of claim 1, wherein the photonic interconnect is configured to provide dynamic adjustment of the routing paths based on real-time or near real-time workload requirements.

7. The system of claim 1, wherein the silicon photonic circuitry comprises microring resonators configured to be programmed with tunable synaptic weights.

8. The system of claim 1, wherein the silicon photonic circuitry comprises a reconfigurable mesh of Mach-Zehnder interferometers.

9. A system for heterogeneous computing, the system comprising:
a memristor crossbar;
silicon photonic circuitry;
a photonic interconnect configured to route signals, via routing paths, between the memristor crossbar and the silicon photonic circuitry; and
a processor coupled to the photonic interconnect and configured to control the routing paths between the memristor crossbar and the silicon photonic circuitry.

10. The system of claim 9, wherein the photonic interconnect couples the processor and at least one of the memristor crossbar or the silicon photonic circuitry.

11. The system of claim 9, wherein the photonic interconnect comprises a heterogeneous III-V on Si photonic circuitry configured to couple the memristor crossbar and the silicon photonic circuitry on the same circuit.

12. The system of claim 9, wherein the system is configured to implement a neural network with fixed layers using the memristor crossbar and tunable layers using the silicon photonic circuitry.

13. The system of claim 9, wherein the photonic interconnect is configured to provide dynamic adjustment of routing paths based on real-time or near real-time workload requirements.

14. The system of claim 9, wherein the silicon photonic circuitry comprises microring resonators.

15. The system of claim 9, wherein the silicon photonic circuitry comprises a reconfigurable mesh of Mach-Zehnder interferometers.

16. A method for heterogeneous computing, comprising:
performing matrix-vector multiplications using a plurality of crossbars, wherein the plurality of crossbars comprises a first crossbar and silicon photonic circuitry;
routing signals, via routing paths, between the first crossbar and the silicon photonic circuitry using a photonic interconnect; and
processing signals from the first crossbar and the silicon photonic circuitry using photonic computing circuitry integrated with the photonic interconnect.

17. The method of claim 16, further comprising:
implementing a neural network with fixed layers using the first crossbar and tunable layers using the silicon photonic circuitry.

18. The method of claim 17, further comprising:
performing in-situ hardware-aware training using the tunable layers implemented with the silicon photonic circuitry.

19. The method of claim 16, further comprising:
dynamically adjusting the routing paths in the photonic interconnect based on real-time or near real-time workload requirements.

20. The method of claim 16, further comprising:
programming microring resonators in the silicon photonic circuitry with tunable synaptic weights to implement a plurality of neural network architectures.
